(19) United States
(12) Patent Application Publication
(10) Pub. No.: US 2012/0195364 A1
(43) Pub. Date: Aug. 2, 2012

(54) DYNAMIC MODE SEARCH ORDER CONTROL FOR A VIDEO ENCODER

(75) Inventors: Feng YI, San Jose, CA (US); Chris Y. CHUNG, Sunnyvale, CA (US); Hsi-Jung WU, San Jose, CA (US); Xiaosong ZHOU, Campbell, CA (US); Yao-Chung LIN, Mountain View, CA (US)

(73) Assignee: APPLE INC., Cupertino, CA (US)

(21) Appl. No.: 13/018,313

(22) Filed: Jan. 31, 2011

(51) Int. Cl. H04N 7/26

(52) U.S. Cl. 375/240.02; 375/E07.027; 375/E07.243

(57) ABSTRACT

A system and method for coding video data wherein a coding mode decision process may be dynamically adjusted according to any of a plurality of factors including video image content, image complexity, motion, channel conditions, the status of the video system components, or other relevant factor. Each of a plurality of potential coding modes may be assigned a weight reflecting an estimation of the likelihood that the coding mode will result in quality image data. The coding mode decision process may then be altered by changing the order of coding modes attempted according to the assigned weight. Code removal and early termination may further alter the coding mode decision process.

### BACKGROUND

Aspects of the present invention relate generally to the field of video processing, and more specifically to dynamically adjust a coding mode decision process.

In conventional video coding systems, an encoder may code a source video sequence into a coded representation that has a smaller bit rate than does the source video and thereby achieve data compression. Video coding systems initially may separate a source video sequence into a series of frames, each frame representing a still image of the video. A frame may be further divided into blocks of pixels. Each frame of the video sequence may then be coded on a block-by-block basis according to any of a variety of different coding techniques. For example, using predictive coding techniques, some frames in a video stream may be coded independently (intra- coded I-frames) and some other frames may be coded using other frames as reference frames (inter- coded frames, e.g., P-frames or B-frames). P-frames may be coded with reference to a single previously coded frame and B-frames may be coded with reference to a pair of previously coded frames. Reference frames may be temporarily stored by the encoder for future use in inter-frame coding.

A video encoder may select from a variety of coding modes to code video data, and each different coding mode may yield a different level of compression, depending upon the content of the source video. In some video coding systems, a video encoder may conventionally code each portion of an input video sequence (for example, each pixel block) according to multiple coding techniques and examine the results to select a preferred coding mode for the respective portion. For example, the video encoder might code the pixel block according to a variety of prediction coding techniques, decode the coded pixel block and estimate whether distortion induced in the decoded pixel block by the coding process would be perceptible.

Coding mode decisions may identify the best pixel block coding modes supported by the video coding system. In conventional video coding systems, a mode decision may be made with a fixed order of mode search steps. Implementing each mode step in a fixed order may be a time and resource intensive process that may negatively impact real-time video encoding operation. Conventional coding systems may try each potential coding mode on a pixel block and select the best mode from all those attempted. Early determination and mode removal may improve encoder latency, but such techniques are usually not sufficient for real-time video encoders. Still other encoders simply attempt inter-coding modes first and if that coding technique fails, the pixel block will be intra-coded. Accordingly, there is a need in the art for an efficient and flexible method for coding mode selection in video coding systems.

### BRIEF DESCRIPTION OF THE DRAWINGS

The foregoing and other aspects of various embodiments of the present invention will be apparent through examination of the following detailed description thereof in conjunction with the accompanying drawing figures in which similar reference numbers are used to indicate functionally similar elements.

FIG. 1 is a simplified block diagram illustrating components of an exemplary video coding system according to an embodiment of the present invention.

FIG. 2 is a simplified block diagram illustrating components of an exemplary video encoder according to an embodiment of the present invention.

FIG. 3 is a simplified flow diagram illustrating a method of encoding video frames according to an embodiment of the present invention.

FIG. 4 is a simplified flow diagram illustrating a method of encoding video frames according to an embodiment of the present invention.

FIG. 5 is a simplified flow diagram illustrating a method of encoding video frames according to an embodiment of the present invention.

### DETAILED DESCRIPTION

Embodiments of the present invention provide a video coding system for coding video data wherein a coding mode decision process may be adjusted dynamically according to any of a plurality of factors including video image content, image complexity, motion, channel conditions, the status of the video system components, or other factors. Where a video encoder may select from a variety of coding modes each of a plurality of potential coding modes may be assigned a weight reflecting an estimation of the likelihood that the coding mode will result in quality image data. The coding mode decision process may then be adjusted by sorting the order of coding modes attempted according to the assigned weight. According to some embodiments, coding modes that are assigned a weight below a predetermined weight threshold may be removed from the coding mode decision process.

Code removal and early termination may further alter the coding mode decision process. The quality of the coded image date may be determined by calculating an error or other measure of quality between the coded video data and the original video data. The error may then be compared to an error threshold to evaluate the quality of the coded video data. When a coding mode is attempted that meets the predefined quality requirements, the coding mode may be selected. The error and weight thresholds may be dynamically altered based on the same factors that influenced the weight assignment.

A selected coding mode may be applied to a single pixel block, a plurality of pixel blocks, a single frame, or a sequence of frames. Dynamically reordering the mode search steps based on the statistics of video inputs, video encoder internal states, and the status of hardware resources may therefore result in a more efficient coding mode decision process.

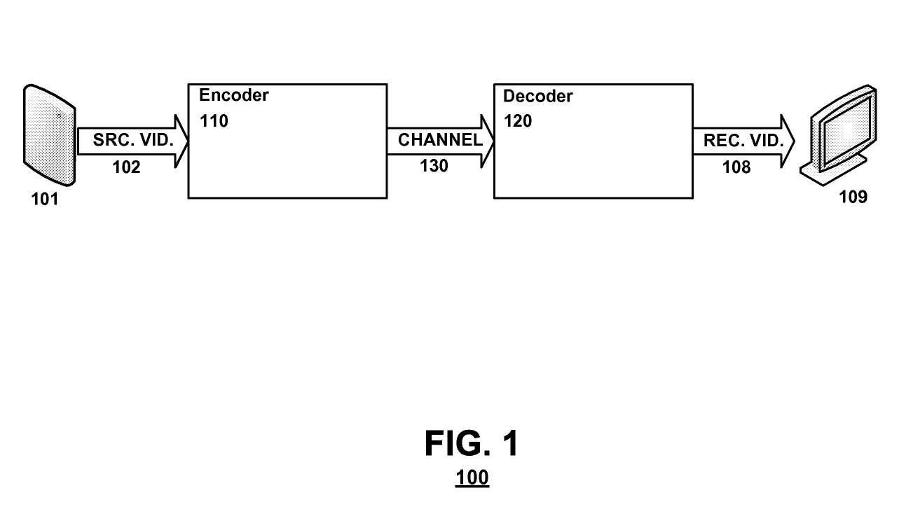

FIG. 1 is a simplified block diagram illustrating components of an exemplary video coding system 100 according to an embodiment of the present invention. As shown, the video coding system 100 may include an encoder 110 and a decoder 120. The encoder may receive an input source video sequence 102 from a video source 101, such as a camera or storage device. As will be further explained, the encoder 110 may then process the input source video sequence 102 as a series of frames and dynamically adjust the coding mode decision process to optimize resource usage and maintain image quality. For example, the order of the available coding modes attempted while making a coding mode decision to code a pixel block may be adjusted based on the image complexity of the pixel block.

Using predictive coding techniques, the encoder 110 may then compress the processed video data using a prediction technique that exploits spatial and/or temporal redundancies in the input source video sequence 102. The resulting compressed sequence may occupy less bandwidth than the source video sequence 102 when it is transmitted to a decoder 120 via a channel 130. The channel 130 may be a transmission medium provided by communications or computer networks, for example either a wired or wireless network.

The decoder 120 may receive the compressed video data from the channel 130 and prepare the video for the display 109 by inverting coding operations performed by the encoder 110. The decoder 120 further may prepare the decompressed video data for the display 109 by filtering, de-interlacing, scaling or performing other processing operations on the decompressed sequence that may improve the quality of the video displayed. The processed video data 108 may be displayed on a screen or other display 109. Alternatively, it may be stored in a storage device (not shown) for later use.

As illustrated in FIG. 1, the functional blocks support video coding and decoding in one direction only. For bidirectional communication, an encoder 110 and decoder 120 may each be implemented on terminals such that each terminal may capture video data at a local location and code the video data for transmission to the other terminal via the network 130. Each terminal 110, 120 may receive the coded video data of the other terminal from the network 130, decode the coded data and display video data recovered therefrom. Embodiments of the present invention find application with personal computers (both desktop and laptop computers), tablet computers, computer servers, media players, and/or dedicated video conferencing equipment. The channel 130 represents any channel provided by a network that may convey coded video data between the encoder 110 and the decoder 120, including for example wireline and/or wireless communication networks. The channel 130 may transmit data in circuit-switched or packet-switched channels. Representative networks include telecommunications networks, local area networks, wide area networks and/or the Internet. For the purposes of the present discussion, the architecture and topology of the channel 130 is immaterial to the operation of the present invention unless explained hereinbelow.

According to an embodiment of the present invention, the factors considered while making a coding mode decision may dynamically change the video coding system syntax. The encoder 110 may indicate which variable length lookup table the decoder 120 is to utilize to interpret the header information transmitted from the encoder 110 to the decoder 120. Dynamically altering the syntax based on the factors that will likely determine the selected coding mode may facilitate more efficient decoding.

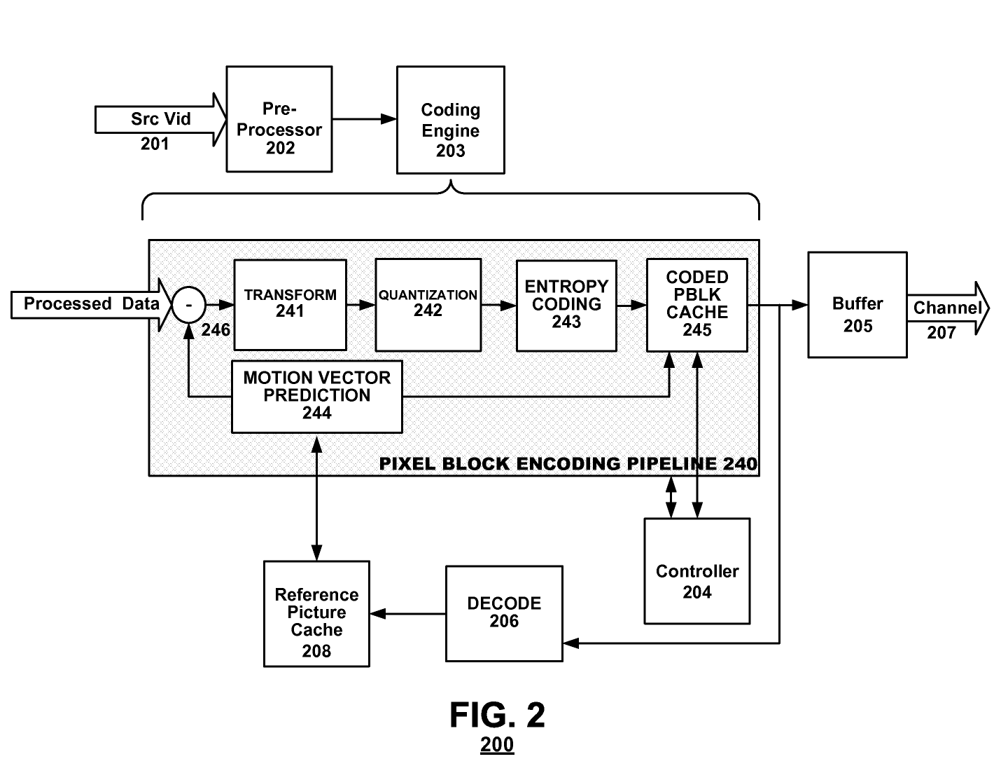

FIG. 2 is a simplified block diagram illustrating components of an exemplary video encoder 200 according to an embodiment of the present invention. As shown, encoder 200 may include a pre-processor 202, a coding engine 203 with a reference picture cache 208, a controller 204, a video data buffer 205, and a decoder 206.

The pre-processor 202 may perform video processing operations to condition the source video sequence 201 to render bandwidth compression more efficient or to preserve image quality in light of anticipated compression and decompression operations. The pre-processor 202 may include an array of filters (not shown) such as de-noising filters, sharpening filters, smoothing filters, bilateral filters and the like that may be applied dynamically to the source video based on characteristics observed within the video. The pre-processor 202 may include its own controller (not shown) to review the source video data from the camera and select one or more of the filters for application. The pre-processor 202 may additionally separate the source video sequence 201 into a series of frames, if not already done, each frame representing a still image of the video.

The coding engine 203 may receive the processed video data from the pre-processor 202. The coding engine 203 may operate according to a predetermined protocol, such as H.263, H.264, or MPEG-2. The coded video data, therefore, may conform to a syntax specified by the protocol being used. In its operation, the coding engine 203 may perform various compression operations, including predictive coding operations that exploit temporal and spatial redundancies in the source video sequence 201 in accordance with the parameters set by the controller 204.

The coding engine 203 may include a pixel block encoding pipeline 240 further including a transform unit 241, a quantizer unit 242, an entropy coder 243, a motion vector prediction unit 244, a coded pixel block cache 245, and a subtractor 246. The transform unit 241 converts the incoming pixel block data into an array of transform coefficients, for example, by a discrete cosine transform (DCT) process or wavelet process. The transform coefficients can then be sent to the quantizer unit 242 where they are divided by a quantization parameter. The quantized data may then be sent to the entropy coder 243 where it may be coded by run-value or run-length or similar coding for compression. The coded data can then be sent to the motion vector prediction unit 244 to generate predicted pixel blocks. The motion vector prediction unit 244 may also supply engine parameters such as parameters for prediction type and motion vectors for coding to the channel. The subtractor 246 may compare the incoming pixel block data to the predicted pixel block output from motion vector prediction unit 244, thereby generating data representative of the difference between the two blocks. However, non-predictively coded blocks may be coded without comparison to the reference pixel blocks. The coded pixel blocks may then be temporarily stored in the block cache 245 until they can be output from the encoding pipeline 240.

Reference frames may be decoded and stored in reference picture cache 208 and may be used by the coding engine 203 during compression to create P-frames or B-frames. The coded frames or pixel blocks may then be output from the coding engine 203. The coded data may be stored by the coded video data buffer 205 where they may be combined into a common bit stream to be delivered by a transmission channel 207.

The controller 204 may receive processed video data from the preprocessor 202. The controller may then determine, based on any of a plurality of factors, for example, the image content, image complexity or motion, camera capture data, the operational settings of the encoder 200 or decoder, the conditions of the channel 207, or the status of the hardware components implementing the video coding system. Evaluating any of these factors, the controller 204 may select a coding mode and provide instructions and adjust parameters of the coding engine 203.

The controller 204 may select a coding mode to be utilized by the coding engine 203 and may control operation of the coding engine 203 to implement each coding mode by setting operational parameters. For example, for each coding mode, the controller 204 may set parameters determining the predictive coding of the pixel blocks (e.g., I-, P- or B-coding), refresh rates for error resiliency, quantization parameters to be used for coefficient truncation, the sizes of images to be coded and the like. The selected coding mode may determine the prediction mode set by the controller 204, for example, by determining that the pixel block is coded using a temporal/motion-predictive coding technique or a spatial predictive coding technique. The selected coding mode may additionally determine the type of reference frame set by the controller 204, for example, by specifying that the pixel block is coded with reference to a Long Term Reference (LTR) frame.

The selected coding mode may additionally determine the size of the pixel block set by the controller 204. Each frame may be parsed into a predetermined number of “pixel blocks,” or regular arrays of pixels of predetermined sizes, typically 4×4, 8×8 or 16×16 pixel arrays. Different frames, however, may be parsed differently. The coding mode may set the size of the pixel array to be coded. Similarly, additional coding engine parameters may be set by the coding mode.

The encoder 200 may further include a decoder 206 that decodes the coded data output from the coding engine 203 by reversing the processes of the coding engine 203 including entropy coding, the quantization, and the transforms. The controller 204 may compare a pixel block decoded by the decoder 206 with an original pixel block from the pre-processor 202 to determine the quality of the frames coded with the selected coding mode. For example, the controller 204 may calculate an error rate, an estimate of the distortion, or a sum of the differences between the two pixel blocks with the comparison to determine an estimate of the quality of the coding mode.

A pixel block may be encoded several times, using various coding modes, in order to determine the best coding mode for coding the pixel block. Differently coded versions of the same pixel block and related coding parameters, including information about the coding technique used and other relevant data, may be stored in a pixel block cache 245 until it can be reviewed by the controller 204 and a coding mode can be selected.

A selected coding mode may be used to code a single pixel block, multiple pixel blocks spatially or temporally adjacent to the pixel block, multiple pixel blocks with similar image content, a single frame, or a sequence of frames.

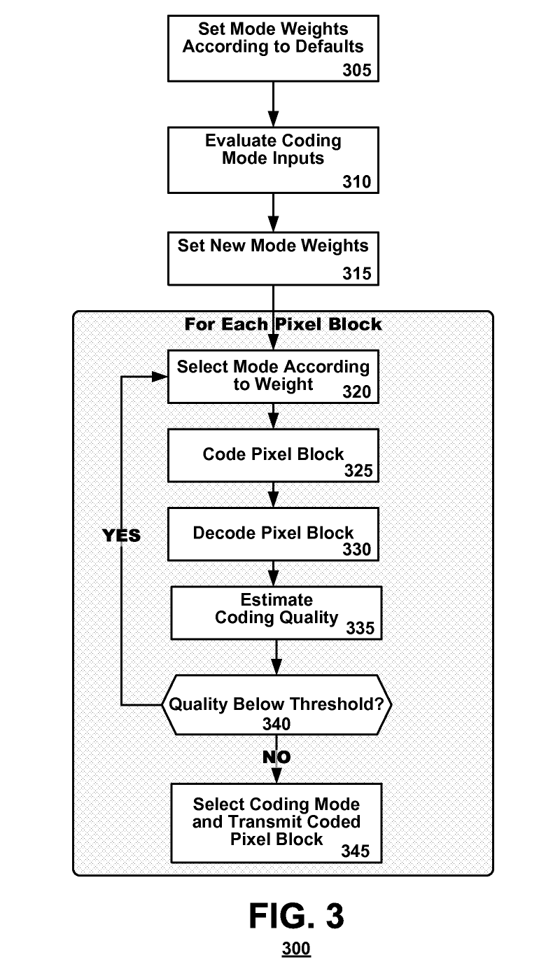

FIG. 3 is a simplified flow diagram illustrating a method 300 of encoding video frames according to an embodiment of the present invention. As previously noted, an encoder may have the resources to code a pixel block according to a plurality of candidate coding modes. An encoder may then reorder the default order that the plurality of candidate coding modes are attempted. For example, according to an embodiment of the present invention, Ffor each pixel block in a frame, each candidate coding mode may be associated with a default weight indicating an estimated likelihood that the associated coding mode will code the pixel block with an acceptable image quality (block 305). Acceptable coding quality may be estimated by identifying an error rate that is less than a predetermined threshold or other measurement of coding quality. The weight may reflect a relative likelihood with respect to the remaining available coding modes. Then, the coding mode that is most likely to provide the best quality as compared to the remaining available coding modes may have the greatest weight. Similarly, the coding mode that is most likely to have the worst quality as compared to all the available coding modes may have the lowest weight.

The method 300 may evaluate coding mode inputs to determine the candidate coding modes with the highest likelihood of producing coded pixel blocks of an acceptable quality (block 310). The coding mode with the greatest weight may be selected from the plurality of available coding modes if the coding mode has not yet been attempted for the current pixel block. The order in which the coding modes are attempted may therefore be determined by the weights assigned to each available coding mode.

Setting a weight for each available coding mode for a pixel block may be influenced by the coding mode inputs including the coding mode(s) selected for spatially or temporally adjacent pixel blocks. Temporally adjacent pixel blocks are pixel blocks in the same location of two different, consecutive frames in a sequence of frames. A coding mode selected as having an acceptable coding quality for an adjacent pixel block may also have an acceptable coding quality for the current pixel block. For example, if a previously coded pixel block was coded using an 8×8 P-type coding mode, then the 8×8 P-type coding mode may have a greater weight then a 16×16 I-type coding mode for the pixel blocks adjacent to the previously coded block.

Similarly, the weight associated with each available coding mode for a pixel block may be influenced by the coding mode(s) used for other pixel blocks in the same frame. For example, a pixel block surrounded by pixel blocks coded with a 4×4 B-type coding mode may have a greater weight associated with a 4×4 B-type coding mode than with a 16×16 I-type coding mode. Then, the coding mode(s) selected as having an acceptable coding quality for other pixel blocks in the frame may also have an acceptable coding quality for the current pixel block. The coding mode(s) used in the frame may be evaluated, such that the coding mode used the most often in the frame has the greatest influence on the weights of the available coding modes for the current pixel block. Or the coding mode(s) used the most often for the pixel blocks in a region of the frame nearest to the current pixel block may have a greater influence on the weights of the available coding modes for the current pixel block as compared to the coding mode(s) used in spatially distant pixel blocks. Or the coding mode that had an acceptable coding quality combined with the least rejections for poor coding quality, regardless of the number of times that coding mode was selected as the coding mode for the pixel blocks in the frame, may have an influence on the weights of the available coding modes for the current pixel block. Similar determinations based on temporally adjacent frames may also have an influence on the weights of the available coding modes for the current pixel block. Thus, statistics reflecting the coding history of the current frame or previously coded frames may be used to adjust the weights associated with each available coding mode for a pixel block.

The weights associated with each available coding mode for a pixel block may be influenced by the image content of the pixel block. For example, a complex pixel block containing many edges may have a greater weight associated with a 4×4 I-type coding mode than a pixel block in a relatively smooth region of the frame. The image content may be evaluated using a variance calculation, where a low variance indicates a low detail, or smooth, pixel block and a high variance indicates a high complexity pixel block. Thus, data related to the image content for the pixel block may be used to adjust the weights associated with each available coding mode for a pixel block.

Other factors may have an influence on the weights associated with each available coding mode for a pixel block. For example, the temporal complexity may be a factor in determining the weights associated with each available coding mode for a pixel block. Temporal complexity may be estimated by calculating the motion between the current frame and another frame, a reference frame for example. Pixel blocks having significant temporal complexity may have a greater weight associated with coding modes that facilitate coding such complex blocks than with other coding modes. Similarly, coding mode complexity may be a consideration. Coding modes that are more complex to encode or decode may be given less weight than simpler coding modes.

Additionally, the operational status of the system components, such as the CPU usage or power consumption, may be a factor such that coding modes that are less resource intensive may have a greater weight than the available coding modes that may utilize significant resources. Similarly, channel conditions may influence the coding mode weights such that if there is significant congestion on the channel, coding modes that result in significant compression may be given greater weight than coding modes that result in less compressed video data thereby lessoning the impact of the coded pixel block on an already congested channel.

The evaluation of coding mode inputs may facilitate setting new mode weights for each available coding mode (block 315). The weight may be set for a single pixel block, a plurality of pixel blocks, a frame, or a sequence of frames. The set weights may then be used in the coding mode decision process. As shown in FIG. 3, a coding mode may be selected from the plurality of coding modes for each pixel block according to the associated weights (block 320).

Then the pixel block may be coded with the selected coding mode (block 325). The coded pixel block may be decoded (block 330) and the quality of the video coding mode estimated (block 335). As previously noted, coding mode quality may be estimated by calculating an error value for the decoded pixel block as compared to the original pixel block, by determining an estimation of the distortion induced in the coded pixel block, by calculating a sum of the differences between the pixel blocks, or by another measurement of image quality.

If the quality of the decoded pixel block is below a predetermined quality threshold (block 340), another coding mode may be attempted. The coding mode with the next highest weight may be selected next. If the quality of the decoded pixel block is greater than a predetermined quality threshold, the current coding mode may be set as the final selected coding mode and the pixel block may be transmitted to a decoder (block 345). As shown in FIG. 3, early termination may be applied to limit the number of coding modes attempted for each pixel block, thus once an acceptable coding mode is identified, no additional coding modes may be attempted or evaluated thereby limiting the resources used in making the coding mode decision.

In accordance with an aspect of the present invention, early termination may be implemented only for some pixel blocks, for example, if the system conditions indicate that computing resources should be conserved where possible, for example, to limit the power consumption, then early termination may be desirable. However, if image quality is the primary concern, then early termination may not be desirable in order to find the best coding mode available. Additionally, the statistics for the coding history of the frame sequence may indicate that early termination is desirable where the coding mode assigned the highest weight was selected for coding in a plurality of previously coded pixel blocks. Then, the coding mode prediction is trending accurately, and early termination may be desirable.

According to an embodiment of the present invention, the predetermined quality threshold used to determine if the coding quality of a coded pixel block is acceptable may additionally be influenced by the factors evaluated for setting the coding mode weights. For example, if power consumption is a concern, the method 300 may accept a lower quality with coding modes that may utilize less power. Similarly, when the channel becomes congested, the method 300 may accept a lower quality with coding modes that may result in significant compression. In some instances, different coding modes may have different thresholds.

According to an embodiment of the present invention, mode removal may be applied to limit the number of coding modes attempted for each pixel block. With mode removal, a coding mode known to be inappropriate for the pixel block may be removed from the plurality of available coding modes for the pixel block. For example, a coding mode may be removed because the image content is too complex to be effectively coded with the coding mode, because no appropriate reference frames are available for use with an inter-coding type coding mode, or because the coding mode may require significant system resources that may not currently be available. A coding mode may be removed from the plurality of available coding modes for a pixel block, a plurality of pixel blocks, a frame, or a sequence of frames.

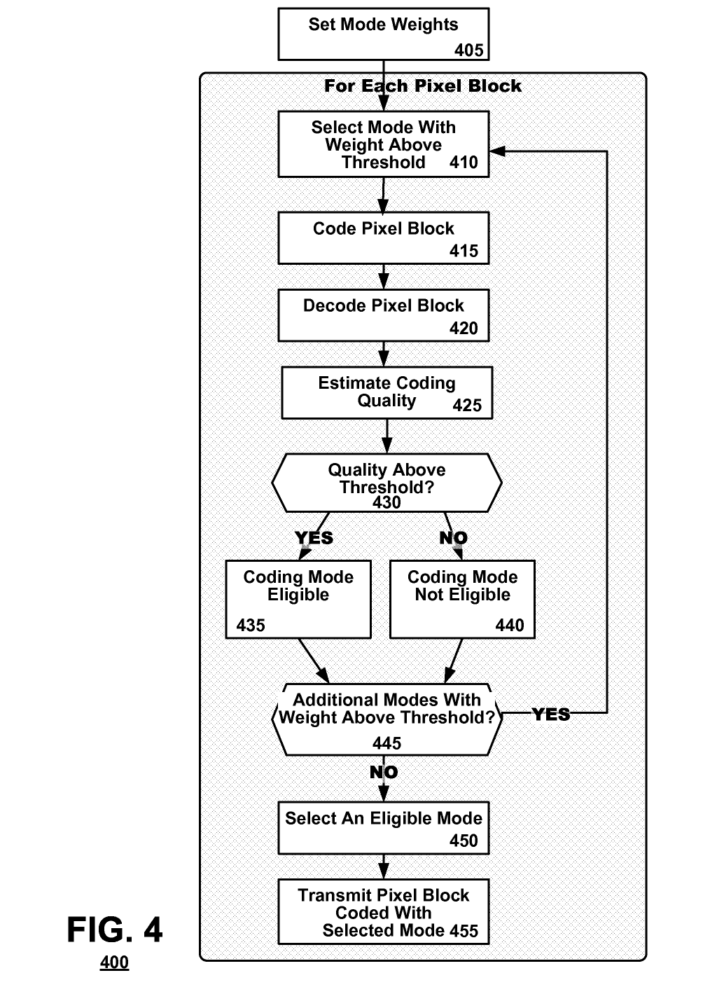

According to an embodiment of the present invention, early termination may be implemented when the available coding modes having a weight above a predetermined threshold have been attempted. FIG. 4 is a simplified flow diagram illustrating a method 400 of encoding video frames according to an embodiment of the present invention. As shown in FIG. 4, an evaluation of coding mode inputs may facilitate setting mode weights for each available coding mode (block 405) and a coding mode with a weight over a predetermined weight threshold may be selected from the plurality of known coding modes (block 410). Then the pixel block may be coded with the selected coding mode (block 415). The coded pixel block may be decoded (block 420) and the quality of the coding mode estimated (block 425).

If the quality of the coding mode is greater than a predetermined error threshold (block 430), the coding mode may be eligible for final selection (block 435). If the quality of the coding mode is less than a predetermined error threshold (block 430), the coding mode is not eligible for final selection (block 440). Then, if there are no additional modes with a weight above the predetermined weight threshold (block 445), one of the eligible coding modes may be selected (block 450) and the pixel block coded according to the selected coding mode may be transmitted (block 455).

Then, according to method 400, only the coding modes with the highest likelihood of yielding acceptable coding quality may be attempted. The coding modes unlikely to have acceptable coding quality may not be attempted, thus saving the time and resources needed to attempt each additional coding mode.

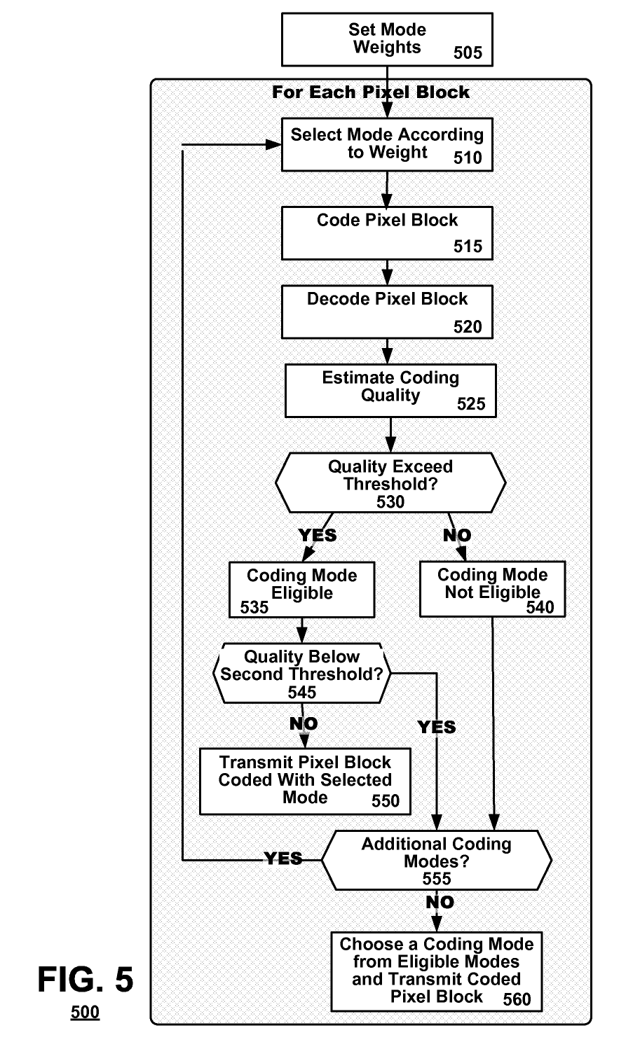

According to an embodiment of the present invention, early termination may be implemented where a coding mode is selected that has a coding quality above a first and a second threshold, but if not such coding mode is attempted, then a final coding mode may be selected from the coding modes that have a coding quality above a first threshold but not above a second threshold. FIG. 5 is a simplified flow diagram illustrating a method 500 of encoding video frames according to an embodiment of the present invention. As shown in FIG. 5, an evaluation of coding mode inputs may facilitate setting mode weights for each available coding mode (block 505). The weights associated with each available coding mode may be set for a single pixel block, a plurality of pixel blocks, a single frame, or a sequence of frames.

A coding mode may be selected from the plurality of available coding modes (block 510) where the coding mode with the greatest weight may be selected first from the available coding modes. Then the pixel block may be coded with the selected coding mode (block 515). The coded pixel block may be decoded (block 520) and the quality of the coding mode may be estimated (block 525).

If the quality of the decoded pixel block is less than the first predetermined quality threshold (block 530), the coding mode is not eligible for final selection (block 540). If the quality of the decoded pixel block is greater than a predetermined threshold (block 530), the coding mode may be eligible for final selection (block 535). Then a second threshold may be used to determine if the eligible coding mode is good enough to be selected as the final coding mode. If the quality is greater than a second quality threshold (block 545), the coding mode may be selected and the pixel block transmitted (block 550). If the quality is less than a second threshold (block 545), another coding mode may be attempted. Then, if there are no additional coding modes to attempt (block 555), one of the eligible modes having a quality below the second threshold may be may be selected (block 560). In an embodiment, the coding mode with the highest quality may be selected. Alternatively, additional parameters may be considered when selecting an eligible coding mode. For example, the decode complexity of the coding mode or the resilience of the coding mode to transmission errors may be considered when selecting a coding mode from the eligible coding modes. Then, the pixel block coded according to the selected coding mode may be transmitted (block 560).

The foregoing discussion identifies functional blocks that may be used in video coding systems constructed according to various embodiments of the present invention. In practice, these systems may be applied in a variety of devices, such as mobile devices provided with integrated video cameras (e.g., camera-enabled phones, entertainment systems and computers) and/or wired communication systems such as videoconferencing equipment and camera-enabled desktop computers. In some applications, the functional blocks described hereinabove may be provided as elements of an integrated software system, in which the blocks may be provided as separate elements of a computer program. In other applications, the functional blocks may be provided as discrete circuit components of a processing system, such as functional units within a digital signal processor or application-specific integrated circuit. Still other applications of the present invention may be embodied as a hybrid system of dedicated hardware and software components. Moreover, the functional blocks described herein need not be provided as separate units. For example, although FIG. 2 illustrates the components of the encoder such as the controller 204, the decoder 206 and the video data buffer 205 as separate units, in one or more embodiments, some or all of them may be integrated and they need not be separate units. Such implementation details are immaterial to the operation of the present invention unless otherwise noted above.

While the invention has been described in detail above with reference to some embodiments, variations within the scope and spirit of the invention will be apparent to those of ordinary skill in the art. Thus, the invention should be considered as limited only by the scope of the appended claims.

We claim:

1. A method of coding a frame of video data, comprising:
for a source pixel block in the frame, assigning weights to a plurality of candidate coding modes based on an indicator associated with the respective pixel block,
selecting a coding mode for a source pixel block by, iteratively, starting with a highest weighted coding mode and proceeding in order according to weight:
coding the source pixel block according to a respective candidate coding mode,
decoding the coded pixel block, and
estimating a coding quality of the candidate mode based on source pixel block data and the decoded pixel block data,
wherein a final coding mode is selected to be a first candidate coding mode for which the estimated coding quality exceeds a predetermined threshold.

2. The method of claim 1 wherein the indicator is pattern of coding assignments made to co-located pixel blocks of previously coded frames.

3. The method of claim 1 wherein the indicator is a pattern of coding assignments made to other pixel blocks of same frame.

4. The method of claim 1 wherein the indicator is a complexity of the source pixel block.

5. The method of claim 1 wherein the indicator is a motion vector calculated between the source pixel block and a reference frame.

6. The method of claim 1 wherein the indicator is a complexity of the candidate coding mode.

7. The method of claim 1 wherein the indicator is a condition of a system implemented to code the video frame data.

8. The method of claim 1 wherein the estimated coding quality is a calculation of error between the source pixel block data and the coded pixel block data.

9. The method of claim 1 wherein the estimated coding quality is a calculation of distortion between the source pixel block data and the coded pixel block data.

10. The method of claim 1 wherein the estimated coding quality is a sum of the absolute difference between the coded pixel block data and the source pixel block data.

11. The method of claim 1 wherein the predetermined threshold is set dynamically based on the indicator.

12. The method of claim 1 wherein the predetermined threshold is different for different candidate coding modes.

13. The method of claim 1 further comprising removing a coding mode assigned a weight below a predetermined weight threshold from the plurality of candidate coding modes.

14. A method of coding a frame of video data, comprising:
for a source pixel block in the frame, assigning weights to a plurality of candidate coding modes based on an indicator associated with the respective pixel block,
sorting the candidate coding modes into an application order based on their respective weights,
coding the source pixel block according to each candidate coding mode in order until a candidate coding mode is found that achieves a predetermined coding quality, and outputting coded pixel block data according to the candidate coding mode associated with the achieved coding quality.

15. The method of claim 14 wherein the indicator is pattern of coding assignments made to co-located pixel blocks of previously coded frames.

16. The method of claim 14 wherein the indicator is a pattern of coding assignments made to other pixel blocks of same frame.

17. The method of claim 14 wherein the indicator is a complexity of the source pixel block.

18. The method of claim 14 wherein the indicator is a motion vector calculated between the source pixel block and a reference frame.

19. The method of claim 14 wherein the indicator is a complexity of the candidate coding mode.

20. The method of claim 14 wherein the indicator is a condition of a system implemented to code the video frame data.

21. A method of coding a frame of video data, comprising:
for a source pixel block in the frame, assigning weights to a plurality of candidate coding modes based on an indicator associated with the respective pixel block,
selecting a coding mode for a source pixel block by, iteratively, starting with a highest weighted coding mode and proceeding in order according to weight:
coding the source pixel block according to a respective candidate coding mode,
decoding the coded pixel block, and
estimating a coding quality of the candidate mode based on source pixel block
data and the decoded pixel block data,
wherein a final coding mode is selected to be a first candidate coding mode for which the estimated coding quality exceeds a first and a second predetermined threshold, or is selected from the candidate coding modes that exceed the first predetermined threshold but do not exceed the second predetermined threshold.

22. The method of claim 21 wherein the indicator is pattern of coding assignments made to co-located pixel blocks of previously coded frames.

23. The method of claim 21 wherein the indicator is a pattern of coding assignments made to other pixel blocks of same frame.

24. The method of claim 21 wherein the indicator is a complexity of the source pixel block.

25. The method of claim 21 wherein the indicator is a motion vector calculated between the source pixel block and a reference frame.

26. The method of claim 21 wherein the indicator is a complexity of the candidate coding mode.

27. The method of claim 21 wherein the indicator is a condition of a system implemented to code the video frame data.

28. A method of coding video comprising:
setting a weight for each of a plurality of candidate coding modes;
coding an original pixel block by each of the candidate coding modes in order by weight;
estimating a quality for each candidate coding mode by comparing data of the coded pixel blocks of each candidate mode to data of the original pixel block;
selecting a candidate coding mode associated with a coded pixel block having a quality above a predetermined threshold as a final coding mode for the pixel block; and
outputting the coded pixel block coded according to the final coding mode to a transmission channel.

29. The method of claim 28 further comprising coding a plurality of pixel blocks according to the final coding mode.

30. The method of claim 28 wherein the variety of coding modes includes coding modes for coding according to a variety of prediction types.

31. The method of claim 28 wherein the variety of coding modes includes coding modes for coding according to a variety of pixel block types.

32. The method of claim 28 wherein the estimated quality is a calculated error between data of the original pixel block and data of the coded pixel blocks of each candidate coding mode.

33. The method of claim 28 wherein the estimated quality is a calculated is a sum of the absolute difference between a coded pixel block and the original pixel block.

34. The method of claim 28 wherein setting the weight for a candidate coding mode further comprises evaluating the image content of the original pixel block.

35. The method of claim 28 wherein setting the weight for a candidate coding mode further comprises evaluating a condition of a system implemented to code the video.

36. The method of claim 28 wherein setting the weight for a candidate coding mode further comprises evaluating a plurality of coding modes used for a pixel block adjacent to the original pixel block.

37. The method of claim 28 further comprising changing the video coding syntax based on the weight set for each candidate coding mode.

38. The method of claim 28 wherein a value of the predetermined threshold is based on a coding mode.

39. The method of claim 28 further comprising removing a coding mode assigned a weight below a predetermined weight threshold from the plurality of candidate coding modes.

40. A method of coding video comprising:
setting a weight for each of a plurality of candidate coding modes;
for each of the candidate coding modes, until a coding mode is selected:
coding an original pixel block into a coded pixel block with a candidate coding mode in order by weight;
calculating a quality estimate for the coded pixel block as compared to the original coding block;
if the coded pixel block has a quality estimate above a predetermined threshold, selecting the coding mode and outputting the coded pixel block coded according to the selected coding mode to a transmission channel.

41. The method of claim 40 wherein setting the weight for a candidate coding mode further comprises evaluating the image content of the original pixel block.

42. The method of claim 40 wherein setting the weight for a candidate coding mode further comprises evaluating conditions of a system implemented to code the video.

43. The method of claim 40 wherein setting the weight for a candidate coding mode further comprises evaluating a coding mode selected for a pixel block adjacent to the original pixel block.

44. A video coding system comprising:
a controller to set a weight for each of a plurality of candidate coding modes, to calculate a quality estimate for a coded pixel block as compared to an original pixel block, and to select a candidate coding mode associated with a quality estimate above a predetermined threshold; and
a coding engine to create coded pixel blocks by coding the original pixel block according to the plurality of candidate coding modes in order by weight.

45. The system of claim 44 wherein the coding engine further codes a plurality of pixel blocks according to the selected coding mode.

46. The system of claim 44 wherein the controller sets the weight for a candidate coding mode by evaluating the image content of the original pixel block.

47. The system of claim 44 wherein the controller sets the weight for a candidate coding mode by evaluating a pattern of coding modes selected for pixel blocks adjacent to the original pixel block.

48. The system of claim 44 wherein the controller sets the weight for a candidate coding mode by evaluating a pattern of coding assignments made to co-located pixel blocks of previously coded frames.

49. The system of claim 44 wherein the wherein the controller sets the weight for a candidate coding mode by evaluating a pattern of coding assignments made to other pixel blocks of same frame.

50. The system of claim 44 wherein the controller sets the weight for a candidate coding mode by evaluating the system conditions of the video encoder.

51. The system of claim 44 wherein the controller removes a coding mode set a weight below a predetermined weight threshold from the plurality of candidate coding modes.

52. A video coding system comprising:
a controller to set a weight for each of a plurality of candidate coding modes; and
a coding engine;
wherein, for each candidate coding mode in order by weight, until a final coding mode is selected:
the coding engine to create a coded pixel block by coding the original pixel block according to the candidate coding mode;
the controller to calculate a quality estimate for the coded pixel block as compared to the original pixel block; and
the controller to select the candidate coding mode if the quality estimate is above a predetermined threshold.

53. The system of claim 52 wherein the coding engine further codes a plurality of pixel blocks according to the selected coding mode.

54. The system of claim 52 wherein the controller sets the weight for each candidate coding mode by evaluating the image content of the original pixel block.

55. The system of claim 52 wherein the controller sets the weight for each candidate coding mode by evaluating the system conditions of the video encoder.

56. The system of claim 52 wherein the controller sets the weight for each candidate coding mode by evaluating the final coding mode selected for a pixel block adjacent to the original pixel block.
